(19) United States
(12) Patent Application Publication
(10) Pub. No.: US 2026/0343598 A1
(43) Pub. Date: Oct. 29, 2026

(54) Method and Apparatus for Communication between Devices

(71) Applicant: Telefonaktiebolaget LM Ericsson (pub), Stockholm (SE)

(72) Inventors: Zhang Zhang, Beijing, Hebei (CN); Min Wang, Luleå (SE); Nithin Srinivasan, Köln (DE); Jan Christoffersson, Luleå (SE)

(21) Appl. No.: 19/114,235

(22) PCT Filed: Sep. 22, 2023
(86) PCT No.: PCT/EP2023/076267

§ 371 Date: Mar. 21, 2025

(30) Foreign Application Priority Data
Sep. 23, 2022 (WO) PCT/CN2022/120962

(51) Int. Cl. H04W 74/0808; H04W 74/00; H04W 92/18

(52) U.S. Cl. CPC H04W 74/0808; H04W 74/002; H04W 92/18

(57) ABSTRACT

Embodiments of the present disclosure provide a method and an apparatus for communication between devices. A method (100) performed by a first communication device comprises: receiving (S102) a first message originated from a second communication device; determining (S104) whether a message in a plurality of messages to be transmitted has a destination associated with the second communication device; selecting (S106) a second message from the plurality of messages; and transmitting (S108) the second message. According to embodiments of the present disclosure, by determining whether a message has a destination associated with the second communication device, the first communication device may select the desired destination for its transmission, particularly when a current transmission opportunity is required to be used for the second communication device.

### TECHNICAL FIELD

The present disclosure relates generally to the technology of communication network, and in particular, to a method and an apparatus for communication between devices.

### BACKGROUND

This section introduces aspects that may facilitate better understanding of the present disclosure. Accordingly, the statements of this section are to be read in this light and are not to be understood as admissions about what is in the prior art or what is not in the prior art.

The 5G (5th Generation) NR (New Radio) technology supports that, on the Uu interface between UE (User Equipment) and gNB (radio access node of the NR technology), a COT (Channel Occupancy Time) can be shared between the gNB and a UE. A COT is fully determined on whether to be shared with other entities by the COT initiating entity (e.g., the gNB). According to 3GPP TS 38.212 V17.3.0, COT sharing information carries indicators indicating whether the COT is to be shared. For example, the COT sharing is indicated via channel access type in DCI (Downlink Control Information), see clause 7.3.1.1 of 3GPP TS 38.212. Upon reception of the COT information indicating that the COT is shared, the receiving UE reacts by joining the COT and performing transmission in the COT, skipping the regular type 1 LBT (Listen Before Talk) operation. The COT sharing information indicated by the DCI thus decides whether the UE shall use the COT.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

With the existing procedure, the gNB, i.e., the network node, thus decides about the usage of the COT by the UE. Such scheme may however result in inefficient usage of the shared COT, e.g., because the UE might not have any data to be transmitted to the gNB initiating the sharing of the COT, or the gNB may not have up to date buffer status of the UE. Accordingly, benefits from sharing the COT might not be attained. Further, the principles underlying COT sharing initiated by a gNB are not readily applicable to scenarios involving direct communication between UEs, e.g., scenarios where sharing of a COT is initiated by a sidelink UE. Therefore, it is necessary to study the above issues and develop corresponding solutions.

Certain aspects of the present disclosure and their embodiments may provide solutions to these or other challenges. There are, proposed herein, various embodiments which address one or more of the issues disclosed herein.

A first aspect of the present disclosure provides a method performed by a first communication device. The method comprises: receiving a first message originated from a second communication device; determining whether a message in a plurality of messages to be transmitted has a destination associated with the second communication device; selecting a second message from the plurality of messages; and transmitting the second message.

In some embodiments of the present disclosure, a destination of the second message is may be determined as being associated with the second communication device.

In some embodiments of the present disclosure, the method further comprises: prioritizing a message having a destination associated with the second communication device.

In some embodiments of the present disclosure, the first message comprises channel occupancy time, COT, sharing information; and/or the second message is a sidelink message; and/or the second message is transmitted during a COT shared by the second communication device.

In some embodiments of the present disclosure, the second communication device is an initiating device for a COT sharing; and/or the first communication device is a responding device for the COT sharing.

In some embodiments of the present disclosure, the first message is associated with and/or comprises a source Layer2, identifier, ID; and the second message is associated with and/or comprises a destination Layer2 ID.

In some embodiments of the present disclosure, the method further comprises: receiving a third message from a base station and/or the second communication device, indicating that the second communication device has one or more Layer2 IDs.

In some embodiments of the present disclosure, the second message is a unicast message.

In some embodiments of the present disclosure, the destination of the second message is determined as being associated with the second communication device, when the destination Layer2 ID of the second message is the same to the source Layer2 ID of the first message.

In some embodiments of the present disclosure, the destination of the second message is determined as being associated with the second communication device, when the one or more Layer2 IDs in the third message include the destination Layer2 ID of the second message, and a source Layer 2 ID of the third message is the same to the source Layer2 ID of the first message; and/or the one or more Layer2 IDs in the third message include the source Layer2 ID of the first message and the destination Layer2 ID of the second message.

In some embodiments of the present disclosure, the second message is a groupcast message; and the destination Layer2 ID of the second message is associated to a group of communication devices.

In some embodiments of the present disclosure, the method further comprises: receiving a fourth message from a base station and/or the second communication device.

In some embodiments of the present disclosure, the fourth message is a groupcast message; and the destination of the second message is determined as being associated with the second communication device, when a destination Layer2 ID of the fourth message is the same to the destination Layer2 ID of the second message; and/or when a source Layer2 ID of the fourth message is the same to the source Layer2 ID of the first message; and/or when the one or more Layer2 IDs in the third message include the source Layer2 ID of the fourth message, and a source Layer 2 ID of the third message is the same to the source Layer2 ID of the first message, and/or the one or more Layer2 IDs in the third message include the source Layer2 ID of the first message.

In some embodiments of the present disclosure, the fourth message is a group joining message for joining a group.

In some embodiments of the present disclosure, the destination of the second message is determined as being associated with the second communication device, when a source Layer2 ID of the fourth message is the same to the source Layer2 ID of the first message; and when the group is mapped to the destination Layer2 ID of the second message in access stratum, AS, layer.

In some embodiments of the present disclosure, the destination of the second message is determined as being associated with the second communication device, when the fourth message indicates that the first communication device and the second communication device is in the same group mapped to the destination Layer2 ID of the second message in access stratum, AS, layer; and/or when a source Layer2 ID of the fourth message and/or a source Layer2 ID used to send the first message as indicated in the fourth message is the same to the source Layer2 ID of the received first message.

In some embodiments of the present disclosure, the fourth message is received by the first communication device, periodically and/or based on a request from the first communication device.

In some embodiments of the present disclosure, a distance between the first communication device and the second communication device is smaller than a required distance; and/or a link quality between the first communication device and the second communication device is better than a required quality.

In some embodiments of the present disclosure, the second message is a broadcast message; and the destination Layer2 ID of the second message is associated to a broadcast service.

In some embodiments of the present disclosure, the method further comprises: receiving a fifth message from a base station and/or the second communication device.

In some embodiments of the present disclosure, the fifth message is a broadcast message; and the destination of the second message is determined as being associated with the second communication device, when a destination Layer2 ID of the fifth message is the same to the destination Layer2 ID of the second message; and/or when a source Layer2 ID of the fifth message is the same to the source Layer2 ID of the first message; and/or when the one or more Layer2 IDs in the third message include the source Layer2 ID of the fifth message and a source Layer2 ID of the third message is the same to the source Layer2 ID of the first message; and/or the one or more Layer2 IDs in the third message include the source Layer2 ID of the fifth message and the source Layer2 ID of the first message.

In some embodiments of the present disclosure, the destination of the second message is determined as being associated with the second communication device, when the fifth message indicates that the second communication device is interested in a service mapped to the destination of the second message; and/or when a source Layer2 ID of the fifth message and/or a source Layer2 ID used to send the first message as indicated in the fifth message is the same to the source Layer2 ID of the received first message.

In some embodiments of the present disclosure, the fifth message is received by the first communication device, periodically and/or based on a request from the first communication device.

In some embodiments of the present disclosure, the second message is to be received by all communication devices in a vicinity of the first communication device.

In some embodiments of the present disclosure, the first communication device does not use a COT shared by the second communication device for transmitting the second message, when none of the plurality of messages is associated to the second communication device; and/or when the second message is not associated to the second communication device and has a higher priority than a message associated to the second communication device; and/or when the second message has a higher channel access priority class, CAPC, value than a CAPC value associated to the COT shared by the second communication device; and/or when the second message has a CAPC value not belonging to a set of CAPC values allowed by the COT shared by the second communication device.

In some embodiments of the present disclosure, the method further comprises: performing type 1 listen before talk, LBT, and type 2 LBT, simultaneously. The second message has a destination related to the second communication device, if type 1 LBT fails and the type 2 LBT succeeds.

In some embodiments of the present disclosure, the method further comprises: transmitting, to other communication devices or a base station, information about the plurality of messages. The information about the plurality of messages includes at least one of: destinations of the plurality of the messages, priorities of the destinations of the plurality of the messages; and/or durations to transmit the plurality of messages.

In some embodiments of the present disclosure, the second message is transmitted together with one or more other messages using resources in one grant; and a destination of the second message is associated to the second communication device, and one or more destinations of the one or more other messages are not associated to the second communication device.

In some embodiments of the present disclosure, the one or more other messages are piggybacked on the second message.

A second aspect of the present disclosure provides a method performed by a second communication device. The method comprises: transmitting, to a first communication device, a first message; and receiving, from the first communication device, a second message. A destination of the second message is determined by the first communication device as being associated with the second communication device.

In some embodiments of the present disclosure, the first message comprises channel occupancy time, COT, sharing information; and/or the second message is a sidelink message; and/or the second message is transmitted during a COT shared by the second communication device.

In some embodiments of the present disclosure, the second communication device is an initiating device for a COT sharing; and/or the first communication device is a responding device for the COT sharing.

In some embodiments of the present disclosure, the first message is associated with and/or comprises a source Layer2 ID; and the second message is associated with and/or comprises a destination Layer2 ID.

In some embodiments of the present disclosure, the method further comprises: transmitting a third message to a base station and/or the first communication device, indicating that the second communication device has one or more Layer2 IDs.

In some embodiments of the present disclosure, the second message is a unicast message.

In some embodiments of the present disclosure, the destination of the second message is determined as being associated with the second communication device, when the destination Layer2 ID of the second message is the same to the source Layer2 ID of the first message.

In some embodiments of the present disclosure, the destination of the second message is determined as being associated with the second communication device, when the one or more Layer2 IDs in the third message include the destination Layer2 ID of the second message, and a source Layer 2 ID of the third message is the same to the source Layer2 ID of the first message; and/or when the one or more Layer2 IDs in the third message include the source Layer2 ID of the first message and the destination Layer2 ID of the second message.

In some embodiments of the present disclosure, the second message is a groupcast message; and the destination Layer2 ID of the second message is associated to a group of communication devices.

In some embodiments of the present disclosure, the method further comprises: transmitting a fourth message to a base station and/or the first communication device.

In some embodiments of the present disclosure, the fourth message is a groupcast message. The destination of the second message is determined as being associated with the second communication device, when a destination Layer2 ID of the fourth message is the same to the destination Layer2 ID of the second message; and/or when a source Layer2 ID of the fourth message is the same to the source Layer2 ID of the first message; and/or when the one or more Layer2 IDs in the third message include the source Layer2 ID of the fourth message, and a source Layer 2 ID of the third message is the same to the source Layer2 ID of the first message, and/or when the one or more Layer2 IDs in the third message include the source Layer2 ID of the first message.

In some embodiments of the present disclosure, the fourth message is a group joining message for joining a group.

In some embodiments of the present disclosure, the destination of the second message is determined as being associated with the second communication device, when a source Layer2 ID of the fourth message is the same to the source Layer2 ID of the first message; and when the group is mapped to the destination Layer2 ID of the second message in access stratum, AS, layer.

In some embodiments of the present disclosure, the destination of the second message is determined as being associated with the second communication device, when the fourth message indicates that the first communication device and the second communication device is in the same group mapped to the destination Layer2 ID of the second message in access stratum, AS, layer; and/or when a source Layer2 ID of the fourth message and/or a source Layer2 ID used to send the first message as indicated in the fourth message is the same to the source Layer2 ID of the received first message.

In some embodiments of the present disclosure, the fourth message is transmitted by the second communication device, periodically and/or based on a request from the first communication device.

In some embodiments of the present disclosure, a distance between the first communication device and the second communication device is smaller than a required distance; and/or a link quality between the first communication device and the second communication device is better than a required quality.

In some embodiments of the present disclosure, the second message is a broadcast message; and the destination Layer2 ID of the second message is associated to a broadcast service.

In some embodiments of the present disclosure, the method further comprises: transmitting a fifth message to a base station and/or the first communication device.

In some embodiments of the present disclosure, the fifth message is a broadcast message; the destination of the second message is determined as being associated with the second communication device, when a destination Layer2 ID of the fifth message is the same to the destination Layer2 ID of the second message; and/or when a source Layer2 ID of the fifth message is the same to the source Layer2 ID of the first message; and/or when the one or more Layer2 IDs in the third message include the source Layer2 ID of the fifth message and a source Layer2 ID of the third message is the same to the source Layer2 ID of the first message; and/or when the one or more Layer2 IDs in the third message include the source Layer2 ID of the fifth message and the source Layer2 ID of the first message.

In some embodiments of the present disclosure, the destination of the second message is determined as being associated with the second communication device, when the fifth message indicates that the second communication device is interested in a service mapped to the destination of the second message; and/or when a source Layer2 ID of the fifth message and/or a source Layer2 ID used to send the first message as indicated in the fifth message is the same to the source Layer2 ID of the received first message.

In some embodiments of the present disclosure, the fifth message is transmitted by the second communication device, periodically and/or based on a request from the first communication device.

In some embodiments of the present disclosure, the second message is to be received by all communication devices in a vicinity of the first communication device.

In some embodiments of the present disclosure, the method further comprises: receiving, from the first communication device or a base station, information about the second message. The information about the second message includes at least one of: a destination of the second, a priority of the destinations of the second message; and/or a duration to transmit the second message.

In some embodiments of the present disclosure, the second message is transmitted together with one or more other messages using resources in one grant by the first communication device; and a destination of the second message is associated to the second communication device, and one or more destinations of the one or more other messages are not associated to the second communication device.

In some embodiments of the present disclosure, the one or more other messages are piggybacked on the second message.

A third aspect of the present disclosure provides an apparatus for a first communication device. The apparatus for the first communication device may comprise: a processor; a memory, the memory containing instructions executable by the processor. The apparatus for the first communication device is operative for: receiving a first message originated from a second communication device; determining whether a message in a plurality of messages to be transmitted has a destination associated with the second communication device; selecting a second message from the plurality of messages; and transmitting the second message.

In embodiments of the present disclosure, the apparatus may be further operative to perform the method according to any of above embodiments.

A fourth aspect of the present disclosure provides an apparatus for a second communication device. The apparatus for the second communication device may comprise: a processor; a memory, the memory containing instructions executable by the processor. The apparatus for the second communication device is operative for: transmitting, to a first communication device, a first message; and receiving, from the first communication device, a second message. A destination of the second message is determined by the first communication device as being associated with the second communication device.

In embodiments of the present disclosure, the apparatus may be further operative to perform the method according to any of above embodiments.

A fifth aspect of the present disclosure provides computer-readable storage medium storing instructions, which when executed by at least one processor, cause the at least one processor to perform the method according to any of above embodiments.

Another aspect of the present disclosure provides an apparatus for a first communication device. The apparatus for the first communication device is adapted to perform the method according to any of above embodiments.

Another aspect of the present disclosure provides an apparatus for a second communication device. The apparatus for the second communication device is adapted to perform the method according to any of above embodiments.

Another aspect of the present disclosure provides a vehicle. The vehicle may comprise at least one processor and a memory, the memory containing instructions executable by the at least one processor. The vehicle is adapted to perform the method according to any of above embodiments, particularly in the first aspect.

Another aspect of the present disclosure provides a vehicle. The vehicle may comprise at least one processor and a memory, the memory containing instructions executable by the at least one processor. The vehicle is adapted to perform the method according to any of above embodiments, particularly in the second aspect.

Embodiments herein may afford many advantages. According to embodiments of the present disclosure, improved methods and improved apparatuses for communication between devices are provided.

According to embodiments of the present disclosure, by determining whether a message has a destination associated with the second communication device, the first communication device may select the desired destination for its transmission, particularly when a current transmission opportunity is required to be used for the second communication device.

Particularly, the proposed methods in embodiments of the present disclosure enable a UE to select the desired destination for its transmission when using a shared COT for its transmission, which is an essential enabler for COT sharing. Furthermore, the shared COT can be used in a more smart way which improves the system performance.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart for a method performed by a first communication device, according to exemplary embodiments of the present disclosure.

FIG. 1B is an exemplary flow chart showing additional steps of the method showing in FIG. 1A, according to exemplary embodiments of the present disclosure.

FIG. 1C is another exemplary flow chart showing additional steps of the method showing in FIG. 1A, according to exemplary embodiments of the present disclosure.

FIG. 1D is another exemplary flow chart showing additional steps of the method showing in FIG. 1A, according to exemplary embodiments of the present disclosure.

FIG. 1E is another exemplary flow chart showing additional steps of the method showing in FIG. 1A, according to exemplary embodiments of the present disclosure.

FIG. 1F is another exemplary flow chart showing additional steps of the method showing in FIG. 1A, according to exemplary embodiments of the present disclosure.

FIG. 1G is another exemplary flow chart showing additional steps of the method showing in FIG. 1A, according to exemplary embodiments of the present disclosure.

FIG. 1H is another exemplary flow chart showing additional steps of the method showing in FIG. 1A, according to exemplary embodiments of the present disclosure.

FIG. 2A is an exemplary flow chart for a method performed by a second communication device, according to exemplary embodiments of the present disclosure.

FIG. 2B is an exemplary flow chart showing additional steps of the method showing in FIG. 2A, according to exemplary embodiments of the present disclosure.

FIG. 2C is another exemplary flow chart showing additional steps of the method showing in FIG. 2A, according to exemplary embodiments of the present disclosure.

FIG. 2D is another exemplary flow chart showing additional steps of the method showing in FIG. 2A, according to exemplary embodiments of the present disclosure.

FIG. 2E is another exemplary flow chart showing additional steps of the method showing in FIG. 2A, according to exemplary embodiments of the present disclosure.

FIG. 3 is an exemplary flow chart showing an application of exemplary embodiments of the present disclosure.

FIG. 4 is a block diagram showing an exemplary apparatus for a first communication device, which is suitable for performing the method according to embodiments of the disclosure.

FIG. 5 is a block diagram showing an exemplary apparatus for a second communication device, which is suitable for performing the method according to embodiments of the disclosure.

FIG. 6 is a block diagram showing an apparatus/computer readable storage medium, according to embodiments of the present disclosure.

FIG. 7 is a block diagram showing a carrier including an apparatus/computer readable storage medium, according to embodiments of the present disclosure.

FIG. 8 is a block diagram showing modules for a first communication device, which are suitable for performing the method according to embodiments of the disclosure.

FIG. 9 is a block diagram showing modules for a second communication device, which are suitable for performing the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such for an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device/communication device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a vehicle, a drone, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In a communication system, many technologies may be used to improve the efficiency of communication between different devices, so as to tackle with the ever increasing data demand. For example, communication between a first communication device and a second communication device on unlicensed spectrum, as well as the licensed spectrum, may be supported. For increasing the transmission efficiency, a first communication device may use a transmission time, such as COT shared by the second communication device. For using this shared transmission time, one requirement may be that the second communication device is a target of transmission from the first communication device.

In order to tackle with the ever increasing data demand, NR (new radio) is supported on both licensed and unlicensed spectrum (i.e., referred to as NR-U). Compared to the LTE LAA (Long Term Evolution Licensed-assisted access), NR-U supports DC (Dual-Connectivity) and standalone scenarios, where the MAC (Medium Access Control) procedures including RACH (Random Access Channel) and scheduling procedure on unlicensed spectrum are subject to the LBT (Listen before talk) failures, while there was no such restriction in LTE LAA, since there was licensed spectrum in LAA scenario so the RACH and scheduling related signaling can be transmitted on the licensed spectrum instead of unlicensed spectrum.

Access to a channel in the unlicensed spectrum, especially in the 5 GHz and 6 GHz band, is guaranteed by Listen Before Talk (LBT) requirements defined by regulations, unlike licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied (i.e., LBT failed), the device must defer from transmitting. This mechanism reduces interferences and collisions to other systems and increases probabilities of successful transmissions. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

NR-U supports two different LBT modes, dynamic and semi-static channel occupancy for two types of equipment: Load based Equipment (LBE) and Frame based equipment (FBE), respectively.

COT sharing is introduced in 3GPP TS (Technical Specification) 37.213, V17.2.0.

When a node, referred to as initiating node (e.g. gNB/UE in case of NR-U), initiates a channel occupancy by performing a type 1 LBT with an exponential random back-off, it is allowed to share its channel occupancy with other nodes, referred to as responding nodes (UEs/gNB). Depending on the gap between the transmission of the initiating and the responding node, the responding node might or might not be required to perform an LBT for a single observation duration, referred to as type 2 LBT. NR-U supports three flavours of type 2 LBT:
Type 2A: Sensing for 25 us immediately before the start of the transmission;
Type 2B: Sensing for 16 us immediately before the start of the transmission;
Type 2C: Immediate transmission without sensing, in which the duration of the corresponding transmission is at most 584 μs.

SideLink communication is also widely used currently.

3GPP specified the LTE D2D (device-to-device) technology, also known as sidelink (SL) or the PC5 interface, as part of Release 12 (Rel-12). The target use case was the Proximity Services (communication and discovery). Support was enhanced during Rel-13. In Rel-14, the LTE sidelink was extensively redesigned to support vehicular communications (commonly referred to as V2X (vehicle to anything) or V2V (vehicle to vehicle)). Support was again enhanced during Rel-15.

From the point of view of the lowest radio layers, the LTE SL uses broadcast communication. That is, transmission from a UE targets any receiver that is in range.

In Rel-16, 3GPP introduced sidelink for the 5G new radio (NR). The driving use case was vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver. HARQ (Hybrid automatic repeat request) feedback based retransmission is supported for unicast and groupcast.

NR SL introduces 2 stage sidelink control information (SCI), the 1^{st} stage SCI is transmitted on PSCCH (Physical Sidelink Control Channel) and used for the scheduling of PSSCH (Physical Sidelink Shared Channel) and 2^{nd} stage SCI on PSSCH. PSCCH carrying 1^{st} stage SCI and the PSSCH scheduled by the 1^{st} stage SCI are transmitted in the same slot but in different symbols.

NR sidelink transmissions have the following two modes of resource allocations:
Mode 1: Sidelink resources are scheduled by the gNB.
Mode 2: The UE autonomously selects sidelink resources from a (pre-) configured sidelink resource pool(s) based on the channel sensing mechanism.

For RRC (Radio Resource Control) CONNECTED UE, a UE can be configured to adopt either Mode 1 or Mode 2 resource allocation. In other cases, only Mode 2 can be adopted. Furthermore, a RRC CONNECTED mode 2 UE uses dedicated Tx resource pool configured by the gNB using dedicated RRC signaling, a RRC IDLE/INACTIVE mode 2 UE selects a common Tx resource pool to use from the set of common Tx resource pools configured by the gNB using common RRC signaling, an out of coverage mode 2 UE selects a common Tx resource pool to use from the set of preconfigured common Tx resource pools.

For sidelink transmission two sidelink identifiers, e.g., source Layer-2 ID, destination Layer-2 ID, are used (38.300, v17.1.0).

Source Layer-2 ID identifies the sender of the data in NR sidelink communication. The Source Layer-2 ID is 24 bits long and is split in the MAC layer into two bit strings:
First bit string is the least significant bit (LSB) part (8 bits) of Source Layer-2 ID and forwarded to physical layer of the sender. This identifies the source of the intended data in SCI and is used for filtering of packets at the physical layer of the receiver;
Second bit string is the most significant bit (MSB) part (16 bits) of the Source Layer-2 ID and is carried within the MAC header. This is used for filtering of packets at the MAC layer of the receiver.

Destination Layer-2 ID identifies the target of the data in NR sidelink communication. For NR sidelink communication, the Destination Layer-2 ID is 24 bits long and is split in the MAC layer into two bit strings:
First bit string is the LSB part (16 bits) of Destination Layer-2 ID and forwarded to physical layer of the sender. This identifies the target of the intended data in SCI and is used for filtering of packets at the physical layer of the receiver;
Second bit string is the MSB part (8 bits) of the Destination Layer-2 ID and is carried within the MAC header. This is used for filtering of packets at the MAC layer of the receiver.

For two UEs performing sidelink unicast communication there is also a PC5-RRC connection for a pair of Source and Destination Layer-2 IDs associated to the UE pair. A UE pair may have multiple PC5-RRC connections and consequently multiple Source and Destination Layer-2 IDs. Furthermore, a UE may have different Source and/or Destination Layer-2 IDs for transmissions with different cast types.

Sidelink logical channel prioritization (LCP) is further used to regulate different transmissions.

When the MAC entity allocates resources to sidelink LCHs having data available for transmission, it should first select the Layer2 Destination to which the transmission should be performed, based on the highest priority of all the sidelink LCHs belonging to each Layer2 Destination (denoted the priority of the Layer2 Destination). Only LCHs with available data are considered, and the Layer2 Destination having the highest priority is selected. After this, sidelink LCHs belonging to the selected Layer2 Destination are served in decreasing order of priority until either the data for the sidelink logical channel(s) or the sidelink grant is exhausted, whichever comes first.

In the 3GPP Rel. 18, a WI (work item) on sidelink enhancement has been approved (RP-213678), and one of the objectives is to study and specify support of sidelink on unlicensed spectrum (SL-U).

It was agreed in RANI that UE to UE COT sharing is supported for SL-U where Type 2 channel access procedure as defined for NR-U can be applied. Furthermore, when a responding UE uses a COT shared by a COT initiating UE for its transmission(s), the COT initiating UE should be a target receiver of the responding UE's transmission(s).

However, with the current SL LCP procedure, the UE selects a destination having pending SL transmissions with the highest priority among all destinations when obtaining a SL grant. Thus, it cannot be guaranteed that always the destination associated to the COT initiating UE is selected.

Another issue is how the responding UE can determine whether the COT initiating UE is the target receiver of the responding UE's transmission(s), especially for groupcast/broadcast transmission. Even for unicast, in case the COT initiating UE uses different Layer2 IDs for sending the COT sharing info (i.e., information) and receiving the unicast traffic, the responding UE will not know whether the unicast transmission is actually sent to the COT initiating UE which has shared COT with it.

Besides, the restriction that the COT initiating UE should be a target receiver of the responding UE's transmission(s) may lead to degraded performance if the responding UE has traffic to be transmitted to other UE(s) with higher priority.

Therefore, it is necessary to study the above issues and develop corresponding solutions.

Embodiments of the present disclosure may provide some solutions to these issues.

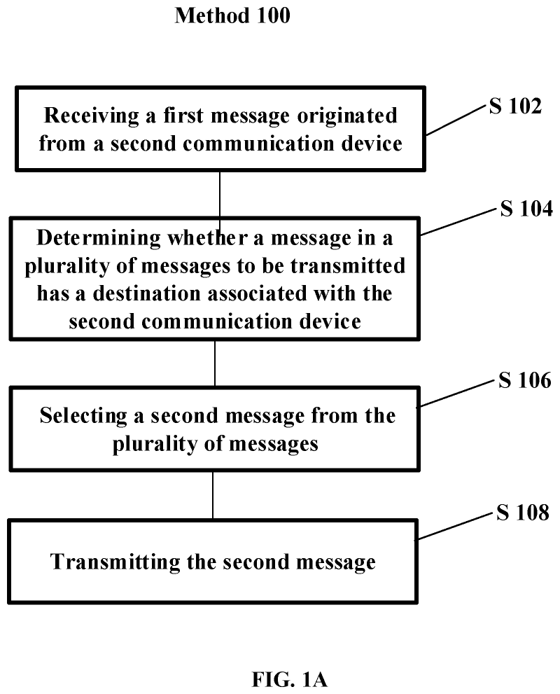

FIG. 1A is an exemplary flow chart for a method performed by a first communication device, according to exemplary embodiments of the present disclosure.

As shown in FIG. 1A, the method 100 comprises: a step S102, receiving a first message originated from a second communication device; a step S104, determining whether a message in a plurality of messages to be transmitted has a destination associated with the second communication device; a step S106, selecting a second message from the plurality of messages; and a step S108, transmitting the second message.

According to some embodiments of the present disclosure, by determining whether a message has a destination associated with the second communication device, the first communication device may select the desired destination for its transmission, particularly when a current transmission opportunity is required to be used for the second communication device.

In some embodiments of the present disclosure, a destination of the second message is determined as being associated with the second communication device. Some exemplary manners to determine the association will be further described below.

According to some embodiments of the present disclosure, the first communication device may directly select the message which is determined as being associated with the second communication device.

FIG. 1B is an exemplary flow chart showing additional steps of the method showing in FIG. 1A, according to exemplary embodiments of the present disclosure.

In some embodiments of the present disclosure, the method 100 further comprises: a step S110, prioritizing a message having a destination associated with the second communication device.

According to some embodiments of the present disclosure, the first communication device may prioritize the message having a destination associated with the second communication device. The priority of such message may be improved by a certain level, which may make the priority of such message to be the highest or not the highest. Then, the first communication device may select the second message based on priority of each message in the plurality of messages.

FIG. 1C is another exemplary flow chart showing additional steps of the method showing in FIG. 1A, according to some exemplary embodiments of the present disclosure.

In some embodiments of the present disclosure, the method 100 further comprises: a step S112, receiving a grant for transmission.

In some embodiments of the present disclosure, the first message comprises channel occupancy time, COT, sharing information; and/or the second message is a sidelink message; and/or the second message is transmitted during a COT shared by the second communication device.

In some embodiments of the present disclosure, the second communication device is an initiating device for a COT sharing; and/or the first communication device is a responding device for the COT sharing.

In some embodiments of the present disclosure, the first message is associated with and/or comprises a source Layer2, identifier, ID; and the second message is associated with and/or comprises a destination Layer2 ID.

According to some embodiments of the present disclosure, such method is applicable to COT sharing.

FIG. 1D is another exemplary flow chart showing additional steps of the method showing in FIG. 1A, according to some exemplary embodiments of the present disclosure.

In some embodiments of the present disclosure, the method 100 further comprises: step S114, receiving a third message from a base station and/or the second communication device, indicating that the second communication device has one or more Layer2 IDs.

In some embodiments of the present disclosure, the second message is a unicast message.

In some embodiments of the present disclosure, the destination of the second message is determined as being associated with the second communication device, when the destination Layer2 ID of the second message is the same to the source Layer2 ID of the first message.

In some embodiments of the present disclosure, the destination of the second message is determined as being associated with the second communication device, when the one or more Layer2 IDs in the third message include the destination Layer2 ID of the second message, and a source Layer 2 ID of the third message is the same to the source Layer2 ID of the first message; and/or the one or more Layer2 IDs in the third message include the source Layer2 ID of the first message and the destination Layer2 ID of the second message.

In some embodiments of the present disclosure, the third message can be the first message. i.e., the information (such as the one or more Layer2 IDs) included in the third message can be put in the first message.

According to some embodiments of the present disclosure, the method may be applicable to transmit/receive a unicast message.

In some embodiments of the present disclosure, the second message is a groupcast message; and the destination Layer2 ID of the second message is associated to a group of communication devices.

FIG. 1E is another exemplary flow chart showing additional steps of the method showing in FIG. 1A, according to some exemplary embodiments of the present disclosure.

In some embodiments of the present disclosure, the method 100 further comprises: a step S116, receiving a fourth message from a base station and/or the second communication device.

In some embodiments of the present disclosure, the fourth message is a groupcast message; and the destination of the second message is determined as being associated with the second communication device, when a destination Layer2 ID of the fourth message is the same to the destination Layer2 ID of the second message; and/or a source Layer2 ID of the fourth message is the same to the source Layer2 ID of the first message; and/or when the one or more Layer2 IDs in the third message include the source Layer2 ID of the fourth message, and a source Layer 2 ID of the third message is the same to the source Layer2 ID of the first message, and/or the one or more Layer2 IDs in the third message include the source Layer2 ID of the first message.

In some embodiments of the present disclosure, the fourth message is a group joining message for joining a group.

In some embodiments of the present disclosure, the destination of the second message is determined as being associated with the second communication device, when a source Layer2 ID of the fourth message is the same to the source Layer2 ID of the first message; and when the group is mapped to the destination Layer2 ID of the second message in access stratum, AS, layer.

In some embodiments of the present disclosure, the fourth message is a PC5-S and/or higher layer message. The destination of the second message is determined as being associated with the second communication device, when the fourth message indicates that the first communication device and the second communication device is in the same group mapped to the destination Layer2 ID of the second message in access stratum, AS, layer; and/or when a source Layer2 ID of the fourth message and/or a source Layer2 ID used to send the first message as indicated in the fourth message is the same to the source Layer2 ID of the received first message.

The fourth message is received by the first communication device, periodically and/or based on a request from the first communication device.

In some embodiments of the present disclosure, a distance between the first communication device and the second communication device is smaller than a required distance; and/or a link quality between the first communication device and the second communication device is better than a required quality.

According to some embodiments of the present disclosure, the method may be applicable to transmit/receive a groupcast message.

In some embodiments of the present disclosure, the second message is a broadcast message; and the destination Layer2 ID of the second message is associated to a broadcast service.

FIG. 1F is another exemplary flow chart showing additional steps of the method showing in FIG. 1A, according to some exemplary embodiments of the present disclosure.

In some embodiments of the present disclosure, the method 100 further comprises: a step S118, receiving a fifth message from a base station and/or the second communication device.

In some embodiments of the present disclosure, the fifth message is a broadcast message. The destination of the second message is determined as being associated with the second communication device, when a destination Layer2 ID of the fifth message is the same to the destination Layer2 ID of the second message; and/or when a source Layer2 ID of the fifth message is the same to the source Layer2 ID of the first message; and/or when the one or more Layer2 IDs in the third message include the source Layer2 ID of the fifth message and a source Layer2 ID of the third message is the same to the source Layer2 ID of the first message; and/or the one or more Layer2 IDs in the third message include the source Layer2 ID of the fifth message and the source Layer2 ID of the first message.

In some embodiments of the present disclosure, the fifth message is a PC5-S and/or higher layer message. The destination of the second message is determined as being associated with the second communication device, when the fifth message indicates that the second communication device is interested in a service mapped to the destination of the second message; and/or when a source Layer2 ID of the fifth message and/or a source Layer2 ID used to send the first message as indicated in the fifth message is the same to the source Layer2 ID of the received first message.

The fifth message may be received by the first communication device, periodically and/or based on a request from the first communication device.

In some embodiments of the present disclosure, the second message is to be received by all communication devices in a vicinity of the first communication device.

According to some embodiments of the present disclosure, the method may be applicable to transmit/receive a broadcast message.

In some embodiments of the present disclosure, the first communication device does not use a COT shared by the second communication device for transmitting the second message, when none of the plurality of messages is associated to the second communication device, e.g., has a destination associated to the second communication device; and/or when the second message is not associated to the second communication device, e.g., has a destination not associated to the second communication device, and has a higher priority than a message associated to the second communication device; and/or when the second message has a higher channel access priority class, CAPC, value than a CAPC value associated to the COT shared by the second communication device; and/or when the second message has a CAPC value not belonging to a set of CAPC values allowed by the COT shared by the second communication device. If the first communication device does not use the shared COT for transmitting the second message, the first communication device may perform regular LBT, e.g., type 1 LBT, for transmitting the second message. The CAPC associated to the COT shared by the second communication device may define a threshold for the CAPC of the second message. The first communication device may determine whether to join the COT based on checking if the CAPC of the second message doesn't meet the threshold, e.g., because the CAPC value of the second message is higher than the threshold.

FIG. 1G is another exemplary flow chart showing additional steps of the method showing in FIG. 1A, according to some exemplary embodiments of the present disclosure.

In some embodiments of the present disclosure, the method 100 further comprises: a step S120, performing type 1 listen before talk, LBT, and type 2 LBT, simultaneously. The second message has a destination related to the second communication device, if type 1 LBT fails and the type 2 LBT succeeds.

According to some embodiments of the present disclosure, the specific second message may be selected based on whether a type 1 LBT or a type 2 LBT succeed.

FIG. 1H is another exemplary flow chart showing additional steps of the method showing in FIG. 1A, according to some exemplary embodiments of the present disclosure.

In some embodiments of the present disclosure, the method 100 further comprises: a step 122, transmitting, to other communication devices or a base station, information about the plurality of messages. The information about the plurality of messages includes at least one of: destinations of the plurality of the messages, priorities of the destinations of the plurality of the messages; and/or durations to transmit the plurality of messages.

In some embodiments of the present disclosure, the second message is transmitted together with one or more other messages using resources in one grant; and a destination of the second message is associated to the second communication device, and a destination of the one or more other messages are not associated to the second communication device.

In some embodiments of the present disclosure, the one or more other messages are piggybacked on the second message.

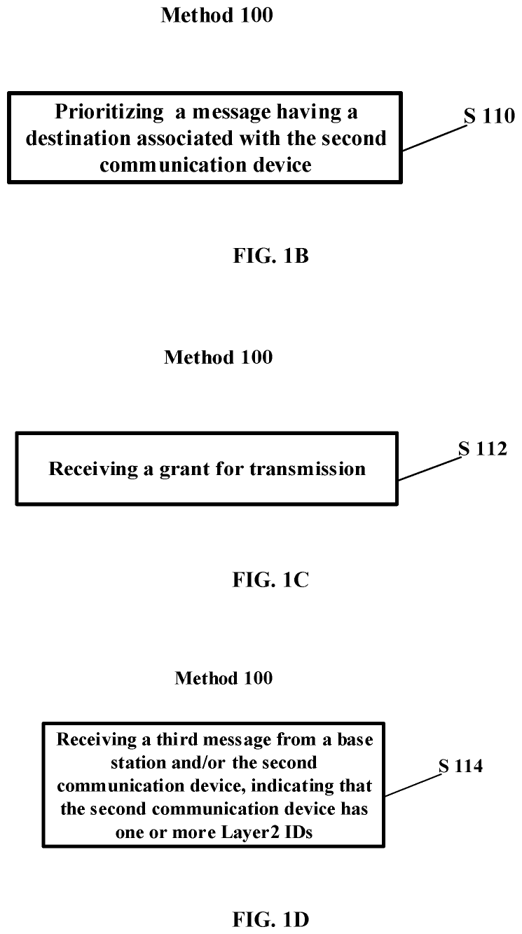

FIG. 2A is an exemplary flow chart for a method performed by a second communication device, according to some exemplary embodiments of the present disclosure.

As shown in FIG. 2A, the method 200 comprises: a step S202, transmitting, to a first communication device, a first message; and a step S204, receiving, from the first communication device, a second message. A destination of the second message is determined by the first communication device as being associated with the second communication device.

In some embodiments of the present disclosure, the first message comprises channel occupancy time, COT, sharing information; and/or the second message is a sidelink message; and/or the second message is transmitted during a COT shared by the second communication device.

In some embodiments of the present disclosure, the second communication device is an initiating device for a COT sharing; and/or the first communication device is a responding device for the COT sharing.

In some embodiments of the present disclosure, the first message is associated with and/or comprises a source Layer2 ID; and the second message is associated with and/or comprises a destination Layer2 ID.

FIG. 2B is an exemplary flow chart showing additional steps of the method showing in FIG. 2A, according to some exemplary embodiments of the present disclosure.

In some embodiments of the present disclosure, the method 200 further comprises: a step S206, transmitting a third message to a base station and/or the first communication device, indicating that the second communication device has one or more Layer2 IDs.

In some embodiments of the present disclosure, the second message is a unicast message.

In some embodiments of the present disclosure, the destination of the second message is determined as being associated with the second communication device, when the destination Layer2 ID of the second message is the same to the source Layer2 ID of the first message.

In some embodiments of the present disclosure, the destination of the second message is determined as being associated with the second communication device, when the one or more Layer2 IDs in the third message include the destination Layer2 ID of the second message, and a source Layer 2 ID of the third message is the same to the source Layer2 ID of the first message; and/or when the one or more Layer2 IDs in the third message include the source Layer2 ID of the first message and the destination Layer2 ID of the second message.

In some embodiments of the present disclosure, the second message is a groupcast message; and the destination Layer2 ID of the second message is associated to a group of communication devices.

FIG. 2C is another exemplary flow chart showing additional steps of the method showing in FIG. 2A, according to some exemplary embodiments of the present disclosure.

In some embodiments of the present disclosure, the method 200 further comprises: a step S208, transmitting a fourth message to a base station and/or the first communication device.

In some embodiments of the present disclosure, the fourth message is a groupcast message. The destination of the second message is determined as being associated with the second communication device, when a destination Layer2 ID of the fourth message is the same to the destination Layer2 ID of the second message; and/or when a source Layer2 ID of the fourth message is the same to the source Layer2 ID of the first message; and/or when the one or more Layer2 IDs in the third message include the source Layer2 ID of the fourth message, and a source Layer 2 ID of the third message is the same to the source Layer2 ID of the first message, and/or when the one or more Layer2 IDs in the third message include the source Layer2 ID of the first message.

In some embodiments of the present disclosure, the fourth message is a group joining message for joining a group.

In some embodiments of the present disclosure, the destination of the second message is determined as being associated with the second communication device, when a source Layer2 ID of the fourth message is the same to the source Layer2 ID of the first message; and when the group is mapped to the destination Layer2 ID of the second message in access stratum, AS, layer.

In some embodiments of the present disclosure, the fourth message is a PC5-S and/or higher layer message. The destination of the second message is determined as being associated with the second communication device, when the fourth message indicates that the first communication device and the second communication device is in the same group mapped to the destination Layer2 ID of the second message in access stratum, AS, layer; and/or when a source Layer2 ID of the fourth message and/or a source Layer2 ID used to send the first message as indicated in the fourth message is the same to the source Layer2 ID of the received first message.

The fourth message may be transmitted by the second communication device, periodically and/or based on a request from the first communication device.

In some embodiments of the present disclosure, a distance between the first communication device and the second communication device is smaller than a required distance; and/or a link quality between the first communication device and the second communication device is better than a required quality.

In some embodiments of the present disclosure, the second message is a broadcast message; and the destination Layer2 ID of the second message is associated to a broadcast service.

FIG. 2D is another exemplary flow chart showing additional steps of the method showing in FIG. 2A, according to some exemplary embodiments of the present disclosure.

In some embodiments of the present disclosure, the method 200 further comprises: a step S210, transmitting a fifth message to a base station and/or the first communication device.

In some embodiments of the present disclosure, the fifth message is a broadcast message. The destination of the second message is determined as being associated with the second communication device, when a destination Layer2 ID of the fifth message is the same to the destination Layer2 ID of the second message; and/or when a source Layer2 ID of the fifth message is the same to the source Layer2 ID of the first message; and/or when the one or more Layer2 IDs in the third message include the source Layer2 ID of the fifth message and a source Layer2 ID of the third message is the same to the source Layer2 ID of the first message; and/or when the one or more Layer2 IDs in the third message include the source Layer2 ID of the fifth message and the source Layer2 ID of the first message.

In some embodiments of the present disclosure, the fifth message is a PC5-S and/or higher layer message. The destination of the second message is determined as being associated with the second communication device, when the fifth message indicates that the second communication device is interested in a service mapped to the destination of the second message; and/or when a source Layer2 ID of the fifth message and/or a source Layer2 ID used to send the first message as indicated in the fifth message is the same to the source Layer2 ID of the received first message.

The fifth message may be transmitted by the second communication device, periodically and/or based on a request from the first communication device.

In some embodiments of the present disclosure, the second message is to be received by all communication devices in a vicinity of the first communication device.

FIG. 2E is another exemplary flow chart showing additional steps of the method showing in FIG. 2A, according to some exemplary embodiments of the present disclosure.

In some embodiments of the present disclosure, the method 200 further comprises: a step S212, receiving, from the first communication device or a base station, information about the second message. The information about the second message includes at least one of: a destination of the second, a priority of the destinations of the second message; and/or a duration to transmit the second message.

In some embodiments of the present disclosure, the second message is transmitted together with one or more other messages using resources in one grant by the first communication device; and a destination of the second message is associated to the second communication device, and one or more destinations of the one or more other messages are not associated to the second communication device.

In some embodiments of the present disclosure, the one or more other messages are piggybacked on the second message.

The embodiments of the present disclosure may provide mechanisms to a UE to determine whether to use a COT shared by another UE for its transmission, and if used, how to select the L2 destination and/or send transmission(s), where the COT initiating UE is not a target UE together with transmission where the COT initiating UE is a target UE.

Aspects of embodiments of the present disclosure include the following.

During the destination selection procedure, the UE prioritizes or only selects from the destinations associated to the COT initiating UEs and having pending traffic.

Criteria and procedures for the responding UE to determine whether the initiating UE is a target receiver of the responding UE's transmission are further provided.

Different criteria and procedures are defined for transmission of different cast types. The case that a UE may have multiple Source and/or Destination Layer-2 IDs is taken into account.

Criteria for the responding UE to determine whether or not to use a COT shared by an initiating UE are further provided.

In a shared COT the responding UE may send transmission(s) where the COT initiating UE is not a target UE together with transmission where the COT initiating UE is a target UE.

The proposed methods in embodiments of the present disclosure enable a UE to select the desired destination for its transmission when using a shared COT for its transmission, which is an essential enabler for COT sharing. Furthermore, the shared COT can be used in a more smart way which improves the system performance.

For clarity, some exemplary embodiments will be further described in the context of NR sidelink (SL) communications in an unlicensed carrier. However, most of the embodiments are in general applicable to any kind of direct communications between devices involving device-to-device (D2D) communications, such as LTE SL in an unlicensed carrier, etc. Embodiments are described from a TX UE and RX UE point of view. Further, it is assumed that a SL UE and its serving gNB (if the UE is in NW (network) coverage) operates with the same radio access technology (RAT) e.g., NR, LTE, and so on. However, all the embodiments apply without loss of meaning to any combination of RATs between the SL UE and its serving gNB.

The link or radio link over which the signals are transmitted between at least two UEs for D2D operation is called herein as the sidelink (SL). The signals transmitted between the UEs for D2D operation are called herein as SL signals. The term SL may also interchangeably be called as D2D link, V2X link, proSe link, peer-to-peer link, PC5 link etc. The SL signals may also interchangeably be called as V2X signals, D2D signals, proSe signals, PC5 signals, peer-to-peer signals etc.

Besides, the unlicensed SL carrier can be in any unlicensed band, e.g., 2.5, 5, 6 GHZ, FR1, FR2, 52.6 GHz-71 GHz, or beyond 100 GHz.

In the below embodiments, a UE which initiates SL transmissions in its proximity is denoted as initiating UE. One or multiple other UEs may receive and read the SL transmissions from the initiating UE. These UEs may provide response/feedback and/or transmit SL traffic to the initiating UE in which case these UEs are denoted as responding UEs. It should be understood that, an initiating UE in one scenario may be an responding UE in another scenario, vice versa.

In the below embodiments, the term “destination” is interchangeably used with the term “destination Layer2 ID”.

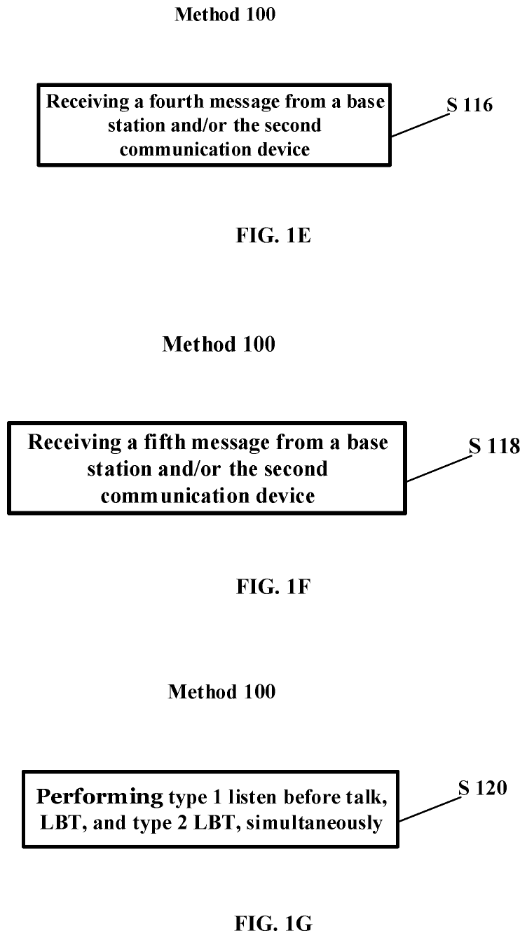

FIG. 3 is an exemplary flow chart showing an application of exemplary embodiments of the present disclosure.

As shown in FIG. 3 UE1 (as the first communication device) received transmissions from UE2 (as the second communication device) and has a usable D2D grant.

UE1 determines whether UE needs to perform transmission where the target receiver(s) include UE2.

If no, UE1 selects a destination as in legacy, and transmits to the selected destination.

If yes, UE1 determines whether UE2 is the target receiver of its transmission to a destination (UE1 determines whether there exist such destinations?). If no, UE 1 stops. If yes, UE1 selects a destination from the determined destinations, and then UE1 transmits to the selected destination.

Some further detailed embodiments will be illustrated for clarity without any limitation.

In the first embodiment, when a responding UE uses one or more shared COT (i.e., perform type 2 LBT) for its (initial) transmission, upon reception of a SL grant (i.e., via Mode 1 resource allocation or Mode 2 resource allocation), the responding UE needs to select a destination (represented by a Layer2 ID) among all destinations to which there are pending traffic to be transmitted for its (initial) SL transmission using the grant. During the selection procedure, the responding UE prioritizes or only selects from the destinations associated to the initiating UEs and having pending traffic (i.e., the UEs initiating the COT are the target receivers of the transmission) over the other destinations not associated to the initiating UEs and having pending traffic. The UE may select a destination not associated to the initiating UEs and having pending traffic when there is no SL traffic to be transmitted to the destinations associated to the initiating UEs.

In the second embodiment, for a unicast transmission from a responding UE to a Layer2 ID (e.g., 111000, denoted the concerned Layer2 ID in below of this embodiment), the responding UE determines that the initiating UE is a target receiver of the responding UE's unicast transmission if any of the following conditions are met:
The responding UE has received an assistance/configuration info (e.g., the COT sharing info, inter-UE coordination info, etc.) where the source Layer2 ID included in the associated SCI and/or the MAC header (denoted source Layer2 ID of the received assistance/configuration info) is the concerned Layer2 ID (111000).
The responding UE has been informed by the initiating UE using e.g., PC5-RRC, that the initiating UE has one or more Layer2 ID(s) (e.g., 110000, 100010, 111000, etc.) used for its unicast communication with the responding UE, where the Layer2 ID(s) include the concerned Layer2 ID (111000). Moreover, the source Layer2 ID with which the above ID info is received (e.g., 101010) is (the same to) the source Layer2 ID of the received assistance/configuration info (i.e., also 101010). Alternatively, the source Layer2 ID of the received assistance/configuration info (e.g., 101010) may be included in the above ID info directly, by which the responding UE knows that the concerned Layer2 ID (111000) and the source Layer2 ID of the received assistance/configuration info (101010) are associated to the same UE (i.e., the initiating UE).

In the third embodiment, for a groupcast transmission from a responding UE to a Layer2 ID which is the Destination Layer2 ID of the groupcast transmission (e.g., 111000, denoted the concerned Layer2 ID in below of this embodiment), the responding UE determines that the initiating UE is a target receiver of the responding UE's groupcast transmission if any of the following conditions are met:
The responding UE has received a groupcast transmission where the destination Layer2 ID of the groupcast transmission is the concerned Layer2 ID (111000) and the source Layer2 ID of the groupcast transmission is the source Layer2 ID of the received assistance/configuration info (e.g., 101010).
The responding UE has received a groupcast transmission where the destination Layer2 ID of the groupcast transmission is the concerned Layer2 ID (111000) and the source Layer2 ID of the groupcast transmission (e.g., 000111) is associated to the initiating UE (i.e., 000111 and 101010 are associated to the same UE). The responding UE can know such association if has been informed that the source Layer2 ID of the received groupcast transmission (000111) and the source Layer2 ID of the received assistance/configuration info (101010) are associated to the same UE (i.e., the initiating UE).
The responding UE can identify that the initiating UE and itself belong to the same group which is mapped to the concerned Layer2 ID in AS layer (the responding UE knows such mapping from core NW or by itself). For instance, the responding UE can make such identification in the following ways:
   It has received a group joining message where the source Layer2 ID of the received group joining message is (the same to) the source Layer2 ID of the received assistance/configuration info (101010) and the group is mapped to the concerned Layer2 ID (111000) in AS layer.
   The responding UE is informed that a UE is a member of a group where the responding UE is also a member of that group and the group is mapped to the concerned Layer2 ID (111000) in AS layer. Besides, the responding UE is also informed about the source Layer2 ID that the UE used to send the assistance/configuration info, which is (the same to) the source Layer2 ID of the received assistance/configuration info (101010). Such informing may be sent via e.g., PC5-S and/or higher layer (e.g., application layer) message. Moreover, it may be sent periodically and/or based on request from the responding UE.

Furthermore, the responding UE may consider the communication range during the determination. More specifically, the responding UE may only consider a UE is a target UE of its groupcast transmission if the UE is within the range requirement of its groupcast transmission, e.g., the distance between the two UEs is smaller than the required distance and/or the link quality between the two UEs is better than the required quality. The responding UE can know the distance to another UE, based on, e.g., the exchange location info, and know the link quality to the UE by measuring the signal from the UE. The UE can know whether the location info/signal and the assistance/configuration info are received from the same UE based on methods similar as described above.

in the fourth embodiment, for a broadcast transmission from a responding UE to a Layer2 ID which is the Destination Layer2 ID of the broadcast transmission (e.g., 111000, denoted the concerned Layer2 ID in below of this embodiment), the responding UE determines that the initiating UE is a target receiver of the responding UE's broadcast transmission if any of the following conditions are met:
The responding UE has received a broadcast transmission where the destination Layer2 ID of the broadcast transmission is the concerned Layer2 ID (111000) and the source Layer2 ID of the broadcast transmission is (the same to) the source Layer2 ID of the received assistance/configuration info (e.g., 101010).
The responding UE has received a broadcast transmission where the destination Layer2 ID of the broadcast transmission is the concerned Layer2 ID (111000) and the source Layer2 ID of the broadcast transmission (e.g., 000111) is associated to the initiating UE. The responding UE can know such association if has been informed that the source Layer2 ID of the received broadcast transmission (000111) and the source Layer2 ID of the received assistance/configuration info (101010) are associated to the same UE (i.e., the initiating UE).
The responding UE is informed by another UE the broadcast service(s) that the UE is interested in where one of the service(s) is mapped to the concerned Layer2 ID (111000) in AS layer. Meanwhile, the source Layer2 ID used to send the informing is (the same to) the source Layer2 ID of the received assistance/configuration info (101010), or the responding UE is informed about the source Layer2 ID that the UE used to send the assistance/configuration info, which is (the same to) the source Layer2 ID of the received assistance/configuration info (101010). Such informing may be sent via e.g., PC5-S and/or higher layer (e.g., application layer) message. Moreover, it may be sent periodically and/or based on request from the responding UE.
The broadcast transmission needs to be received by all the UEs in vicinity such as direct non-relay discovery announcement, etc.

In the fifth embodiment, a UE which may act as an initiating UE may send the relevant info (e.g., the ID info in the second bullet of the second embodiment, the ID and group info in the second and third bullet of the third embodiment, the ID and interested service info in the second and third bullet of the fourth embodiment) to its serving gNB, it may also inform which UEs may be interested in the info it informs the gNB, e.g, the UE(s) to which it may share COT in case it initiates a COT. Correspondingly the gNB may forward the info in DL together with the ID of the initiating UE from which the gNB has received the info, optionally only to the UE(s) which may be interested in the info. When receiving such info, the receiving UE can determine whether a UE is/shall be a target receiver of its transmission to a certain Layer2 ID.

In the sixth embodiment, the responding UE may determine not to use a COT shared by an initiating UE in any one of the following cases:
It does not have any signaling/data to be transmitted where the initiating UE is a target receiver of the transmission.
It has some signaling/data to be transmitted where the initiating UE is a target receiver of the transmission (denoted targeted transmission). However, it has also some other signaling/data to be transmitted where the initiating UE is not a target receiver of the transmission (denoted non-targeted transmission), and the non-targeted transmission has higher priority than the targeted transmission. In this case, the responding UE may prioritize the non-targeted transmission over the targeted transmission.
The targeted transmission has a higher CAPC value than the CAPC value associated with the shared COT (indicated in the COT sharing info).
The targeted transmission has a CAPC value which is not allowed to use the shared COT (i.e., the COT sharing info may indicate a set of CAPC values where only SL transmissions having a CAPC value belonging to the set are allowed to use the COT).

In the seventh embodiment, when being shared with COT(s), the responding UE may perform type 1 and type 2 LBT simultaneously, if type 1 LBT is succeeded, the responding UE performs Destination selection as in legacy (i.e., not prioritize or only select from the destinations associated to the initiating UEs to which there are pending traffic to be transmitted), otherwise if type 2 LBT is succeeded it selects Layer2 Destination as described in the first to the fifth embodiments (i.e., prioritize or only select from the destinations associated to the initiating UEs to which there are pending traffic to be transmitted). Alternatively, the responding UE may perform the two Destination selection procedures simultaneously. The Destination selected according to the legacy procedure is adopted if type 1 LBT is succeeded, otherwise the Destination selected according to the first to the fifth embodiments is adopted if type 2 LBT is succeeded.

In the eighth embodiment, a Tx UE (which may potentially act as a responding UE) may inform the following info to other UE(s) over SL:
The Layer2 Destination ID(s) to which the Tx UE has traffic to transmit and the priority of the Layer2 Destination.
   The Tx UE may only inform Layer2 Destination ID(s) with priority value lower than a threshold (lower priority value corresponding to higher priority) where the threshold is preconfigured or configured by the gNB or informed by other UE(s) which want to receive such info.
The (estimated) duration during which the Tx UE has traffic to be transmitted to each of the Layer2 Destination(s).

The Tx UE may send such info periodically, or based on request from other UE(s) (e.g., the UE(s) which may potentially act as initiating UE(s)), or triggered by events, e.g., when a service is activated and there is/will be traffic generated for that service, when a service is deactivated and no more traffic will be generated for that service, etc.

The Tx UE may inform such info to the gNB in UL, which in turn may inform the info in DL to UEs in its coverage.

When other UE(s) which may potentially act as initiating UE(s) receives such info from a UE, it determines whether the UE may use a shared COT for its transmission if it shares its COT to that UE. If not, the COT initiating UE may not share its COT to that UE.

In the ninth embodiment, when a responding UE is being shared with COT(s), multiple transmission slots (in time/frequency) may be reserved in one grant where type 2 LBT is performed between those slots (in case they are in different time location), furthermore, in part of those transmission slots the responding UE prioritizes or only selects from the destinations associated to the initiating UEs to which there are pending traffic to be transmitted, while in the other part of those transmission slots the responding UE may prioritize or select from the destinations not associated to the initiating UEs to which there are pending traffic to be transmitted.

Alternatively, the responding UE may piggyback the transmissions to destination(s) not associated to the initiating UEs on the transmission to a destination associated to the initiating U.E. This increases the chances of successful channel access for the piggybacked transmissions in a shared COT as type 2 LBT can be applied even the piggybacked transmissions are to destination(s) not associated to the initiating UE.

In the tenth embodiment, for any of the above embodiments, any signaling exchanged between UE and the gNB via Uu interface can be transmitted via at least one of the following alternatives:
RRC signaling
MAC CE
Paging message
Control PDU of a protocol layer (e.g., SDAP, PDCP, RLC, or an adaptation layer in case of SL relay)
L1 signaling on channels such as PRACH, PUCCH, PDCCH etc.

Any signaling exchanged between UEs via the PC5 interface can be transmitted via at least one of the following signaling alternatives:
RRC signaling (e.g., PC5-RRC)
PC5-S signaling
Discovery signaling
MAC CE
Control PDU of a protocol layer (e.g., SDAP, PDCP, RLC, or an adaptation layer in case of SL relay)
L1 signaling on channels such as PSSCH, PSCCH, or PSFCH etc.

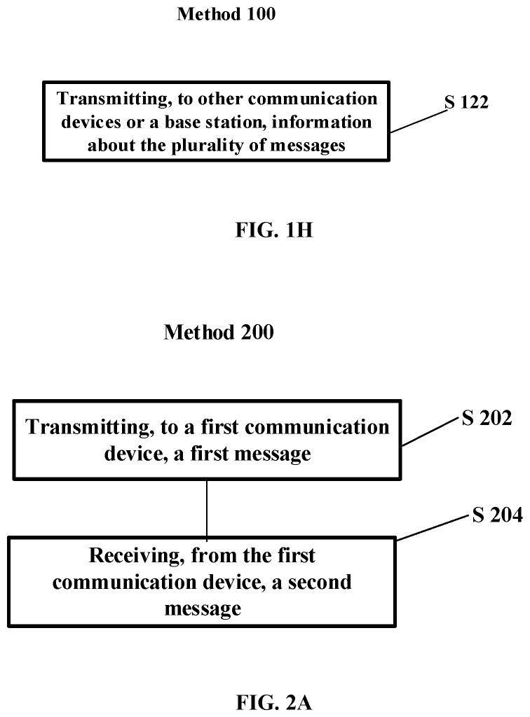

FIG. 4 is a block diagram showing an exemplary apparatus for a first communication device, which is suitable for performing the method according to embodiments of the disclosure.

As shown in FIG. 4, the apparatus 40 for the first communication device comprises: a processor 401, a memory 402. The memory 402 contains instructions executable by the processor 401. The apparatus 40 for the first communication device is operative for: receiving a first message originated from a second communication device; determining whether a message in a plurality of messages to be transmitted has a destination associated with the second communication device; selecting a second message from the plurality of messages; and transmitting the second message.

In embodiments of the present disclosure, the apparatus 40 is further operative to perform the method according to any of the above embodiments, such as these shown in FIG. 1A-1H, etc.

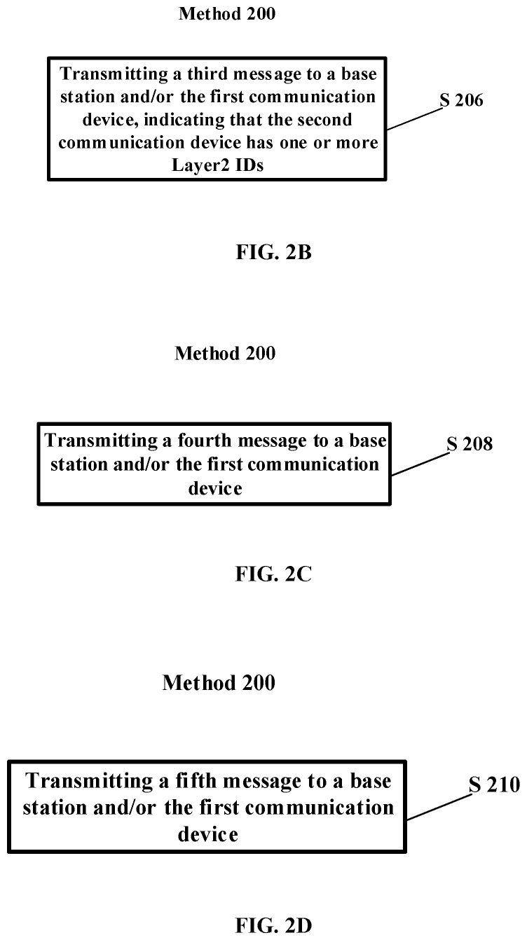

FIG. 5 is a block diagram showing an exemplary apparatus for a second communication device, which is suitable for performing the method according to embodiments of the disclosure.

As shown in FIG. 5, the apparatus 50 for the network node comprises: a processor 501, a memory 502. The memory 502 contains instructions executable by the processor 501. The apparatus 50 for the network node is operative for: transmitting, to a first communication device, a first message; and receiving, from the first communication device, a second message. A destination of the second message is determined by the first communication device as being associated with the second communication device.

In embodiments of the present disclosure, the apparatus 50 is further operative to perform the method according to any of the above embodiments, such as these shown in FIG. 2A-2E, etc.

The processors 401, 501 may be any kind of processing component, such as one or more microprocessor or microcontrollers, as well as other digital hardware, which may include digital signal processors (DSPs), special-purpose digital logic, and the like. The memories 402, 502 may be any kind of storage component, such as read-only memory (ROM), random-access memory, cache memory, flash memory devices, optical storage devices, etc.

Another aspect of the present disclosure provides an apparatus for a first communication device. The apparatus for the first communication device may comprise: a processor; a memory, the memory containing instructions executable by the processor. The apparatus for the first communication device is operative to perform the method according to any of above embodiments.

Another aspect of the present disclosure provides an apparatus for a second communication device. The apparatus for the second communication device may comprise: a processor; a memory, the memory containing instructions executable by the processor. The apparatus for the second communication device is operative to perform the method according to any of above embodiments.

Another aspect of the present disclosure provides a vehicle. The vehicle may comprise: a processor; a memory, the memory containing instructions executable by the processor. The vehicle is operative to perform the method according to any of above embodiments, particularly in the first aspect.

Another aspect of the present disclosure provides a vehicle. The vehicle may comprise: a processor; a memory, the memory containing instructions executable by the processor. The vehicle is operative to perform the method according to any of above embodiments, particularly in the second aspect.

That is, in some scenarios, the apparatus 40, 50 may be vehicle, drone, etc.

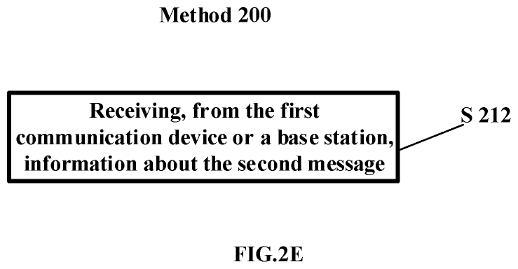

FIG. 6 is a block diagram showing an apparatus/computer readable storage medium, according to embodiments of the present disclosure.

As shown in FIG. 6, the computer-readable storage medium 60, or any other kind of product, storing instructions 601 which when executed by at least one processor, cause the at least one processor to perform the method according to any one of the above embodiments, such as these shown in FIG. 1A-1H, 2A-2E, etc.

The computer readable storage medium can be, for example, an optical compact disk or an electronic memory device like a RAM (random access memory), a ROM (read only memory), Flash memory, magnetic tape, CD-ROM, DVD, Blue-ray disc and the like.

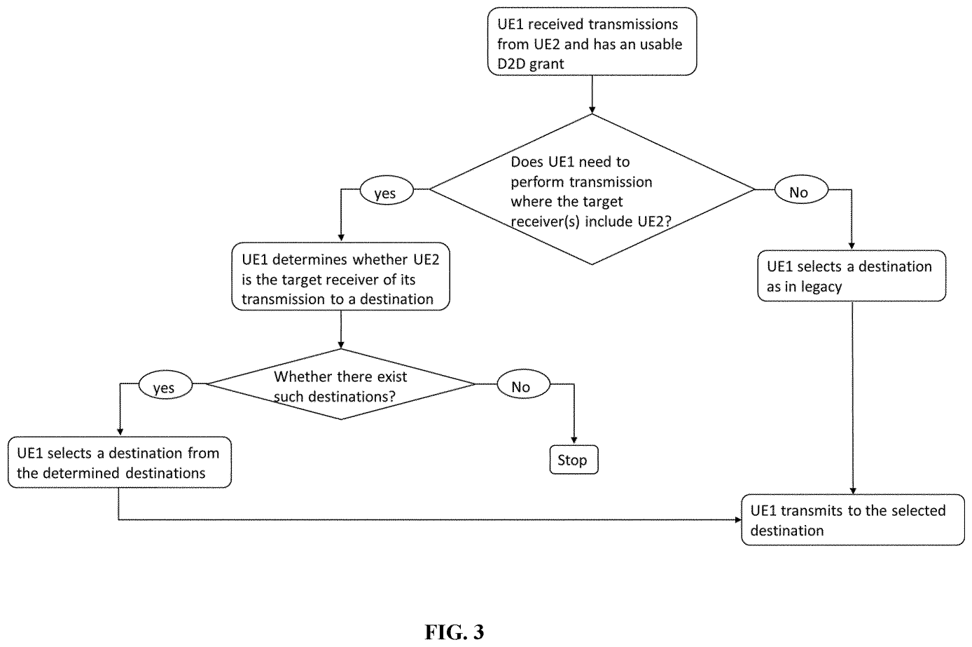

FIG. 7 is a block diagram showing a carrier including an apparatus/computer readable storage medium, according to embodiments of the present disclosure.

In addition, the present disclosure may also provide a carrier 70 containing computer-readable storage medium 60 as mentioned above. Further, the carrier may include one of an electronic signal, optical signal, radio signal, or computer readable storage medium, storing instructions 601.

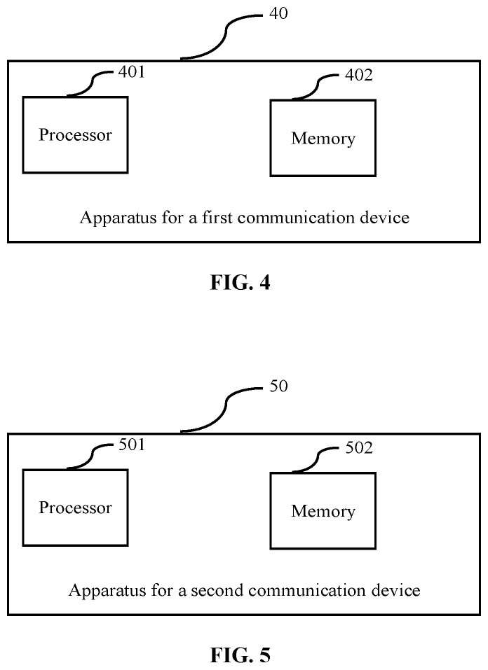

FIG. 8 is a block diagram showing modules for a first communication device, which are suitable for performing the method according to embodiments of the disclosure.

As shown in FIG. 8, the apparatus 80 for the first communication device may comprise: a receiving module 802, configured for receiving a first message originated from a second communication device; a determining module 804, configured for determining whether a message in a plurality of messages to be transmitted has a destination associated with the second communication device; a selecting module 806, configured for selecting a second message from the plurality of messages; and a transmitting module 808, configured for transmitting the second message.

In embodiments of the present disclosure, the apparatus 80 is further operative to perform the method according to any of the above embodiments, such as these shown in FIG. 1A-1H, etc.

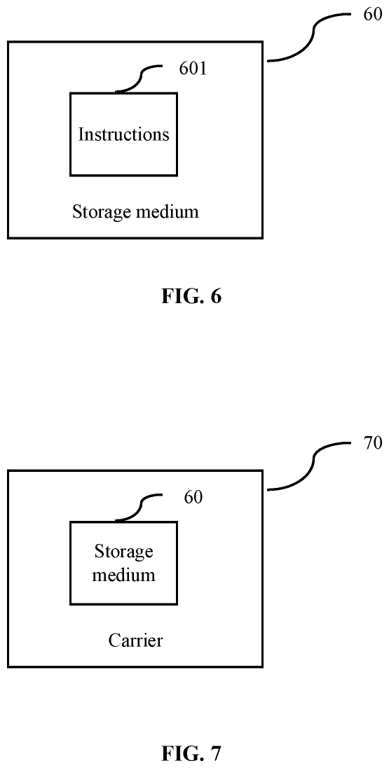

FIG. 9 is a block diagram showing modules for a second communication device, which are suitable for performing the method according to embodiments of the disclosure.

As shown in FIG. 9, the apparatus 90 for the network node may comprise: a transmitting module 902, configured for transmitting, to a first communication device, a first message; and a receiving module 904, configured for receiving, from the first communication device, a second message. A destination of the second message is determined by the first communication device as being associated with the second communication device.

In embodiments of the present disclosure, the apparatus 90 is further operative to perform the method according to any of the above embodiments, such as these shown in FIG. 2A-2E, etc.

These modules may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

The communication device (transmitting end and/or receiving end) may be any kind of communication device, and/or computing device in a network, such as any personal computer, user equipment, router, gateway device, server, etc. Examples for the communication device may be illustrated as follows.

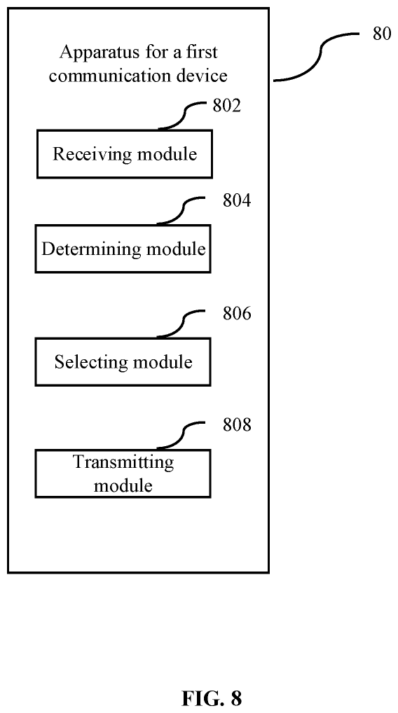

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The communication system 1000 includes a telecommunication network 1002′ that includes an access network 1004′, such as a radio access network (RAN), and a core network 1006′, which includes one or more core network nodes 1008′. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The access network 1004′ includes one or more access network nodes, such as network nodes 1010a′ and 1010b′ (one or more of which may be generally referred to as network nodes 1010′), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

A UE may be connected to more than one telecommunication network. As an example without limitation, the UE 1012D is connected to a plurality of networks including the telecommunication network 1002 and 1002′. The UE 1012D may perform the method according to embodiments of the present disclosure to transmit data by aggerating the telecommunication network 1002 and 1002′.

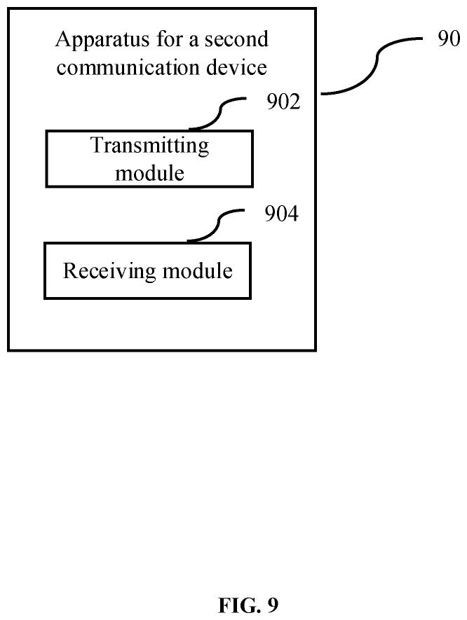

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

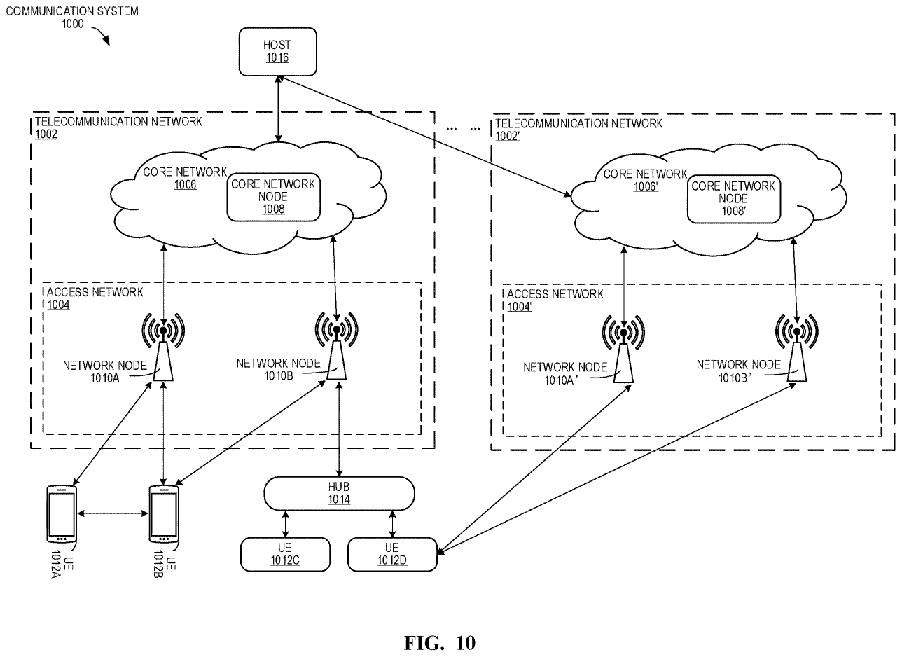

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

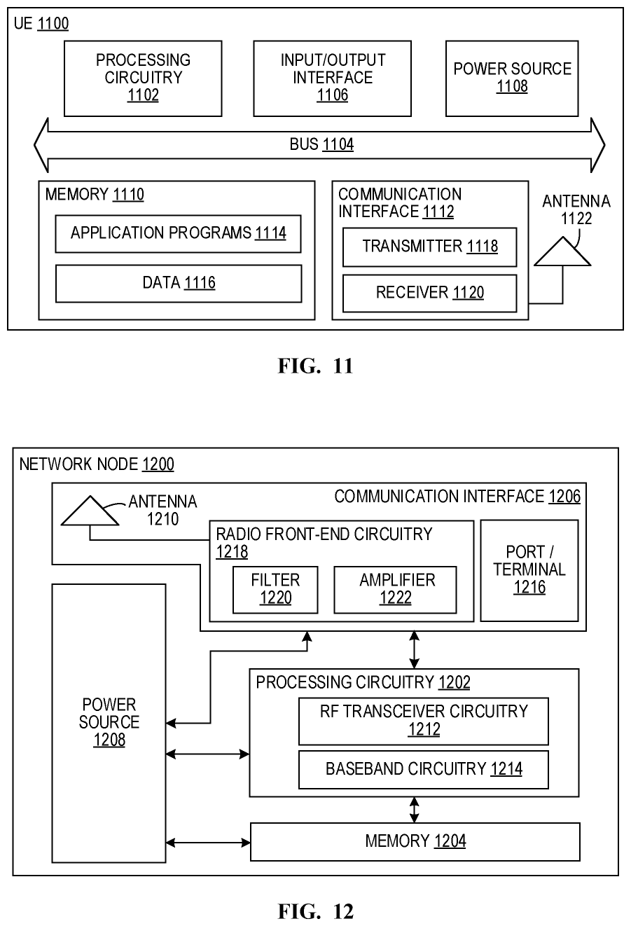

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

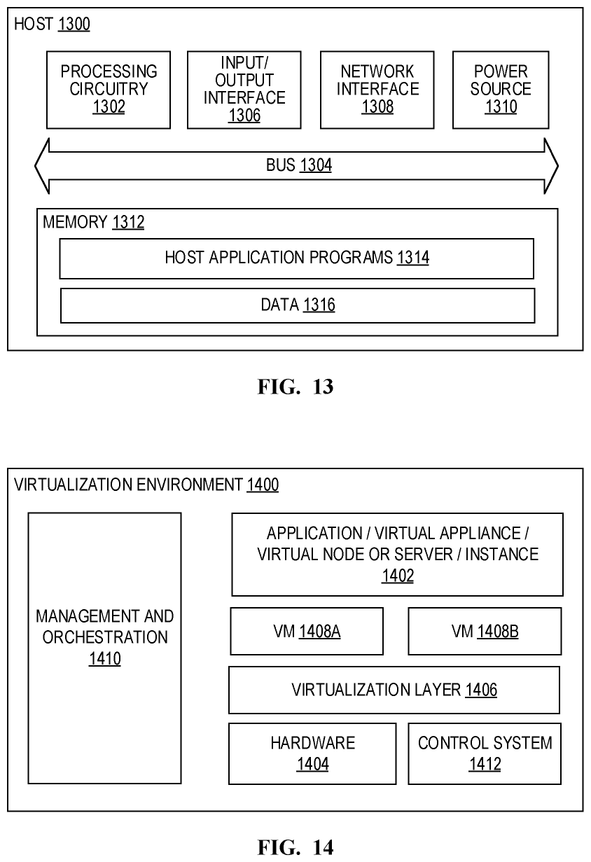

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:
3GPP TS 37.213, V17.2.0, “Physical layer procedures for shared spectrum channel access (Release 17)”
3GPP TS 38.300, v17.1.0, “NR; NR and NG-RAN Overall Description; Stage 2 (Release 17)”
RP-213678, New WID on NR sidelink evolution, 3GPP TSG RAN Meeting #94e, Electronic Meeting, Dec. 6-17, 2021

| ABBREVIATION | EXPLANATION |
|---|---|
| CA | Carrier Aggregation |
| CBR | Channel Busy Ratio |
| CQI | Channel Quality Indicator |
| CSI | Channel State Information |
| DFN | Direct Frame Number |
| DL | Downlink |
| DRX | Discontinuous Reception |
| FDD | Frequency Division Duplex |
| GNSS | Global Navigation Satellite System |
| HARQ | Hybrid automatic repeat request |
| IE | Information Element |
| MAC | Medium Access Control |
| MIB | Master Information Block |
| NSPS | National Security and Public Safety |
| OoC | Out-of-Coverage |
| PDCCH | Physical Downlink Control Channel |
| PDCP | Packet Data Convergence Protocol |
| PDU | Protocol Data Unit |
| PHY | Physical (layer) |
| PL | Path Loss |
| PMI | Precoding Matrix Indicator |
| ProSe | Proximity Services |
| PSCCH | Physical Sidelink Control Channel |
| PSSCH | Physical Sidelink Shared Channel |
| RL | Relay |
| RLC | Radio link control |
| RM | Remote |
| RI | Rank Indicator |
| RRC | Radio Resource Control |
| RSRP | Reference Signal Received Power |
| RSSI | Received Signal Strength Indicator |
| RX | Receive, receiver |
| SFN | System Frame Number |
| SIB | System Information Block |
| SINR | Signal to interference noise ration |
| SL | Sidelink |
| SLRB | Sidelink Radio Bearer |
| SLSS | Sidelink Synchronization Signals |
| SMF | Session Management Function |
| SynchUE | Synchronization UE |
| TDD | Time Division Duplex |
| TETRA | Terrestrial Trunked Radio |
| TA | Time advance |
| TX | Transmit, transmitter |
| UE | User Equipment |
| UL | Uplink |
| UPF | User Plane Function |
| V2V | Vehicle-to-vehicle |
| V2X | Vehicle-to-anything |

1.-65. (canceled)

66. A method performed by a first communication device, comprising:
receiving a first message originated from a second communication device;
determining whether a message in a plurality of messages to be transmitted has a destination associated with the second communication device; and
by said determining, selecting a second message from the plurality of messages,
wherein the first communication device does not use a channel occupancy time (COT) shared by the second communication device for transmitting the second message when the second message has a higher channel access priority class (CAPC) value than a CAPC value associated with the COT shared by the second communication device.

67. The method according to claim 66, wherein a destination of the second message is determined as being associated with the second communication device.

68. The method according to claim 66, further comprising prioritizing a message having a destination associated with the second communication device.

69. The method according to claim 66,
wherein the first message comprises channel occupancy time (COT) sharing information; and/or
wherein the second message is a sidelink message; and/or
wherein the second message is transmitted during the COT shared by the second communication device.

70. The method according to claim 66, wherein the second communication device is an initiating device for a COT sharing and/or wherein the first communication device is a responding device for the COT sharing.

71. The method according to claim 66, further comprising receiving a third message from a base station and/or the second communication device, indicating that the second communication device has one or more Layer2 IDs.

72. The method according to claim 66, wherein the second message is a unicast message.

73. The method according to claim 72, wherein the destination of the second message is determined as being associated with the second communication device when a destination Layer2 ID of the second message is the same as a source Layer2 ID of the first message.

74. The method according to claim 71, wherein the destination of the second message is determined as being associated with the second communication device when:
one or more Layer2 IDs in the third message include a destination Layer2 ID of the second message and a source Layer 2 ID of the third message is the same as a source Layer2 ID of the first message; and/or
one or more Layer2 IDs in the third message include a source Layer2 ID of the first message and a destination Layer2 ID of the second message.

75. The method according to claim 66, wherein the second message is a groupcast message, and wherein a destination Layer2 ID of the second message is associated to a group of communication devices.

76. The method according to claim 75, further comprising receiving a fourth message from a base station and/or the second communication device, wherein the fourth message is a groupcast message, and wherein the destination of the second message is determined as being associated with the second communication device:
when a destination Layer2 ID of the fourth message is the same as a destination Layer2 ID of the second message; and/or
when a source Layer2 ID of the fourth message is the same as a source Layer2 ID of the first message; and/or
when one or more Layer2 IDs in a third message include the source Layer2 ID of the fourth message, and a source Layer 2 ID of the third message is the same as a source Layer2 ID of the first message, and/or the one or more Layer2 IDs in the third message include the source Layer2 ID of the first message, wherein the third message is received from a base station and/or the second communication device and indicates that the second communication device has one or more Layer2 IDs.

77. (canceled)

78. The method according to claim 75, further comprising receiving a fourth message from a base station and/or the second communication device, wherein the fourth message is a group joining message for joining a group.

79. The method according to claim 78, wherein the destination of the second message is determined as being associated with the second communication device:
when a source Layer2 ID of the fourth message is the same as a source Layer2 ID of the first message; and
when the group is mapped to a destination Layer2 ID of the second message in an access stratum (AS) layer.

80. The method according to claim 75, further comprising receiving a fourth message from a base station and/or the second communication device, wherein the destination of the second message is determined as being associated with the second communication device:
when the fourth message indicates that the first communication device and the second communication device are in the same group mapped to the destination Layer2 ID of the second message in an access stratum (AS) layer; and/or
when a source Layer2 ID of the fourth message and/or a source Layer2 ID used to send the first message as indicated in the fourth message is the same as a source Layer2 ID of the received first message.

81. The method according to claim 66,
wherein the second message is a broadcast message; and
wherein the destination Layer2 ID of the second message is associated to a broadcast service.

82. The method according to claim 66, wherein the first communication device does not use a COT shared by the second communication device for transmitting the second message:
when none of the plurality of messages is associated to the second communication device; and/or
when the second message is not associated to the second communication device and has a higher priority than a message associated to the second communication device; and/or
when the second message has a CAPC value not belonging to a set of CAPC values allowed by the COT shared by the second communication device.

83. The method according to claim 66, further comprising performing type 1 listen before talk (LBT) and type 2 LBT, simultaneously, wherein the second message has a destination related to the second communication device if type 1 LBT fails and the type 2 LBT succeeds.

84. The method according to claim 66, wherein the second message is transmitted together with one or more other messages using resources in one grant, wherein a destination of the second message is associated to the second communication device, and wherein one or more destinations of the one or more other messages are not associated to the second communication device.

85. An apparatus for a first communication device, wherein the apparatus for the first communication device comprises:
a processor; and
a memory, the memory containing instructions executable by the processor, whereby execution of the instructions causes the first communication device to:
receive a first message originated from a second communication device;
make a determination of whether a message in a plurality of messages to be transmitted has a destination associated with the second communication device; and
based on said determination, select a second message from the plurality of messages,
wherein the first communication device does not use a channel occupancy time (COT) shared by the second communication device for transmitting the second message when the second message has a higher channel access priority class (CAPC) value than a CAPC value associated with the COT shared by the second communication device.

86. A computer-readable storage medium on which is stored instructions that, when executed by at least one processor of a first communication device, cause the at least one first communication device to:
receive a first message originated from a second communication device;
make a determination of whether a message in a plurality of messages to be transmitted has a destination associated with the second communication device; and
based on the determination, select a second message from the plurality of messages, wherein the first communication device does not use a channel occupancy time (COT) shared by the second communication device for transmitting the second message when the second message has a higher channel access priority class (CAPC) value than a CAPC value associated with the COT shared by the second communication device.
